(19) United States
(12) Patent Application Publication
(10) Pub. No.: US 2014/0288883 A1
(43) Pub. Date: Sep. 25, 2014

(54) METHOD FOR DETERMINING AN ANGLE OF A MAGNETIC POLE OF A ROTATING OBJECT

(71) Applicant: INFINEON TECHNOLOGIES AG, Neubiberg (DE)

(72) Inventors: Dirk Hammerschmidt, Villach (AT); Tobias Werth, Villach (AT); Muhammad Adnan, Villach (AT)

(73) Assignee: Infineon Technologies AG, Neubiberg (DE)

(21) Appl. No.: 13/849,674

(22) Filed: Mar. 25, 2013

(51) Int. Cl. B60C 23/06; G01D 9/00

(52) U.S. Cl. CPC B60C 23/061; G01D 9/00
USPC 702/187

(57) ABSTRACT

In various embodiments, a method may include: generating at least one time stamp based on detection of at least a first magnetic field event of at least one pole of a magnetic object during a first rotation; determining a model of the magnetic object based on the at least one time stamp, wherein the model describes a magnetic pattern caused by the first rotation of the magnetic object; generating at least one further time stamp based on detection of at least a second magnetic field event of the at the least one pole of the magnetic object during a second rotation; and updating the model based on the at least one further time stamp.

### TECHNICAL FIELD

Various embodiments relate generally to a method and an arrangement.

### BACKGROUND

Indirect tire pressure monitoring is a technology used in most cars that are sold in non United States of America markets. The base algorithm usually compares an average wheel speed which increases if one of the wheels has a reduced rolling radius due to under inflation of the tire. This allows a detection of pressure loss as long as it does not happen synchronously at each tire. This is the reason why indirect Tire Pressure Monitoring Systems (TPMS) are not sold in the United States of America, since the National Highway Traffic Safety Administration (NTHSA) requires to detect under inflation of a certain absolute level, independent of the state of the other tires. To extend the capability of the indirect systems to fulfill the NTHSA requirement, algorithms that evaluate the influence of the tire pressure on the mechanical resonance frequencies of the wheel structure are required. This is usually done by detection of the resonance oscillations within the signal coming from wheel speed sensors.

The pattern that is introduced by irregularities of e.g. the pole wheel which causes spectral tones that change their frequencies depending on the driving speed. These tones may mask the tire vibration spectrum which has a very small signal energy. Thus, the effect of the pattern should be reduced or even removed, which requires the knowledge of the pattern.

In a conventional system, the patterns are extracted only at the initialization and are rather inaccurate.

### SUMMARY

In various embodiments, a method may include: generating at least one time stamp based on detection of at least a first magnetic field event of at least one pole of a magnetic object during a first rotation; determining a model of the magnetic object based on the at least one time stamp, wherein the model describes a magnetic pattern caused by the first rotation of the magnetic object; generating at least one further time stamp based on detection of at least a second magnetic field event of the at the least one pole of the magnetic object during a second rotation; and updating the model based on the at least one further time stamp.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIG. 1 shows an arrangement in accordance with various embodiments;

FIG. 2 shows a flow diagram illustrating a method in accordance with various embodiments;

FIG. 3 shows a block diagram illustrating various processes in accordance with various embodiments;

FIG. 4 shows a block diagram illustrating various processes in accordance with various embodiments;

FIG. 5 shows a block diagram illustrating various processes in accordance with various embodiments;

FIG. 6 shows a block diagram illustrating an arrangement in accordance with various embodiments;

FIG. 7 shows a block diagram illustrating an arrangement in accordance with various embodiments; and

FIG. 8 shows a block diagram illustrating an arrangement in accordance with various embodiments.

### DESCRIPTION

The following detailed description refers to the accompanying drawings that show, by way of illustration, specific details and embodiments in which the invention may be practiced.

The word “exemplary” is used herein to mean “serving as an example, instance, or illustration”. Any embodiment or design described herein as “exemplary” is not necessarily to be construed as preferred or advantageous over other embodiments or designs.

The word “over” used with regards to a deposited material formed “over” a side or surface, may be used herein to mean that the deposited material may be formed “directly on”, e.g. in direct contact with, the implied side or surface. The word “over” used with regards to a deposited material formed “over” a side or surface, may be used herein to mean that the deposited material may be formed “indirectly on” the implied side or surface with one or more additional layers being arranged between the implied side or surface and the deposited material.

In various embodiments, the pattern (which will also be referred to as model in the following) that is introduced by irregularities of e.g. the pole wheel which causes spectral tones that change their frequencies depending on the driving speed, are not assumed to be constant, that the field strength of the magnetic field may be temperature dependent and the magnetization may be altered by aging effects, furthermore a mechanical displacement of the sensor with respect to the pole wheel may also influence the pattern. Therefore, a continuous update of the pattern is implemented to at least partially compensate for the influence of speed variations during the pattern extraction.

In various embodiments, the extraction and averaging of the length of one or more poles of the magnetic object is continuously repeated, while the starting point for the extraction may optionally be (e.g. continuously) changed during the averaging period to avoid a warping of the pattern depending on the speed variations during the extraction.

As described above, magnetic pole wheels which may be used in vehicles to measure speed may have inherent manufacturing intolerances which give rise to variable magnetic pole length (which will also be referred to as pole length in the following for reasons of simplicity) in each pole wheel. This holds true for any other magnetic object having one or more magnetice poles (which will also be referred to as pole in the following for reasons of simplicity), such as e.g. a magnetic back-biased wheel. Moreover, due to its use in harsh and prone to dust environment and wear and tear, each magnetic pole of a magnetic object such as e.g. a magnetic pole wheel or a magnetic back-biased wheel, may behave differently over a period of time.

An immediate consequence of change in magnetic field characteristic of a particular magnetic pole is the change in length of the pole which is reported by an anti-lock braking system (ABS) sensor.

Various embodiments may accurately measure magnetic pole angles by analyzing a wheel speed sensor signal (e.g. the ABS sensor signal). As will be described in more detail below, various methods may achieve improved pole angle or offset calculation. The computed pole angles will be used to calculate the speed signal more accurately. Besides that, application of pole offset correction will also remove the regular pattern from the speed signal data, which prevails in its spectrum suppressing important information related to tire vibrations which will be used in the determination of a tire pressure.

Thus, the speed signal may e.g. be used in determining a tire pressure model provided for indirect tire pressure measurement. In general, the term “tire” may refer to a piece of rubber or other suitable material which may be mounted onto a wheel of a vehicle (such as e.g. a car, a motorcycle, a truck, and the like). The rubber may be filled with a gas (e.g. compressed air) or other suitable filler material. Various embodiments may be applied to any kind of such tires.

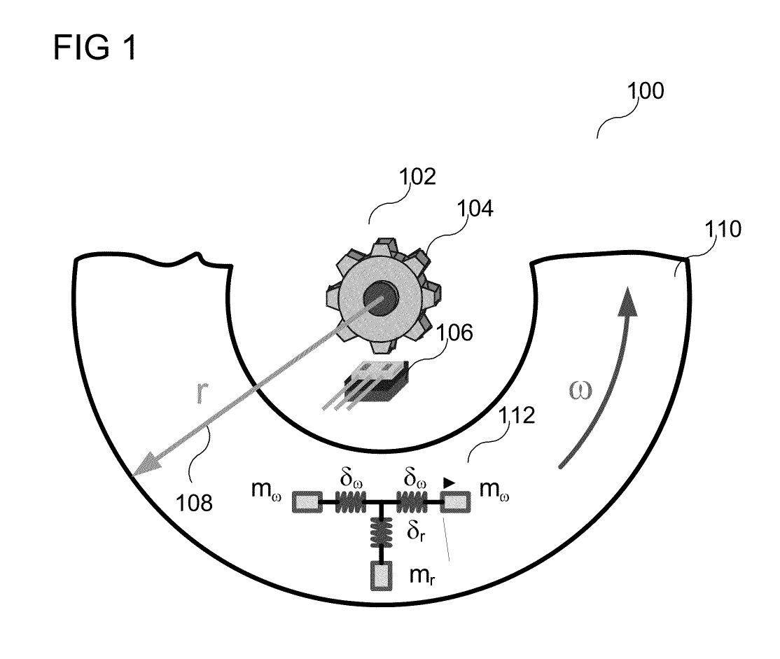

FIG. 1 shows an arrangement 100 in accordance with various embodiments.

As shown in FIG. 1, the arrangement 100 may include a magnetic rotatable object 102, e.g. a magnetic pole wheel 102 or a magnetic back-biased wheel 102. The magnetic rotatable object 102 may include one or a plurality of magnetic poles 104 (e.g. two, three, four, five, six, seven, eight, nine, ten, several tens, e.g. twenty, thirty, etc, in general an arbitrary number of magneticpoles 104). Furthermore, a magnetic sensor 106 may be provided. The magnetic sensor 106 may be configured to detect a magnetic field generated by the rotatable object 102 (the magnetic field is varying in case the rotatable magnetic object 102 is rotated). In various embodiments, the rotatable object 102 and the magnetic sensor 106 may be configured as an anti-lock braking system (ABS) sensor arrangement.

The rotatable object 102 may rotate around a rotation axis 108 and may be mounted on a wheel axle on which a tire 110 may also be mounted.

Signals generated and provided by the magnetic sensor 106 may be used to indirectly determine a tire pressure of a tire 110 during rotation of the magnetic object 102 (and e.g. during rotation of a wheel and a tire 110 the rotatable object 102 may be associated with), using a tire pressure model 112 which may illustratively based on a spring-mass-model and its resonance characteristic (which considers the pole angle(s) and the pole angle offset(s)). The model may take into account vibration phenomena and may carry out a vibration analysis using a model of the frequency spectrum of the vibrations.

In various embodiments, the signals provided by the magnetic sensor 106 (in other words the output of the magnetic sensor 106, e.g. the output of an ABS sensor arrangement) may be a square wave signal whose signal frequency is proportional to the rotational speed of the magnetic object 102 having the one or more magnetic poles 104, such as e.g. a pole wheel 102 or a magnetic back-biased wheel 102. In various embodiments, zero crossings of this square wave signal may be used to calculate the time it takes for a single pole 104 to pass across the magnetic sensor 106.

Assuming that a magnetic object 102 (e.g. pole wheel 102 or a back-biased wheel 102) has N poles 104 and it takes t₁, t₂, . . . , tₙ time in seconds for each pole 104 passing across the sensor 106, then an angle offset δᵢ of each pole i 104 (which may also be referred to as pole angle offset δᵢ of a pole i 104) may be calculated by

$${δ}_{i} = 2 π ( \frac{1}{N} - \frac{{t}_{i}}{{\sum }_{i = 1}^{N} {t}_{i}} ) \\ for \\ i = 1 , 2 , … , N . \qquad ( 1 )$$

Thus, the average speed of one particular revolution (which will also be referred to as rotation in the following) of the magnetic object 102 may be given by

$${ω}_{rev} = \frac{2 π}{{\sum }_{i = 1}^{N} {t}_{i}} . \qquad ( 2 )$$

It is assumed that

$${Θ}_{i} = \frac{2 π}{N}$$

is the ideal pole angle of each pole 104, supposing that all poles 104 have equal length. If \hat{Θ}ᵢ is the pole angle of the n^{th} pole calculated from the average speed over one revolution, then \hat{Θ}ᵢ may be determined by:

\hat{Θ}ᵢ=ωᵣₑᵥtᵢ. (3)

The pole angle offset δᵢ may then be calculated in accordance with

δᵢ=Θᵢ−\hat{Θ}ᵢ, (4)

wherein

$${\sum }_{i = 1}^{N} {δ}_{i} = 0 \\ provided that \\ {\sum }_{i = 1}^{N} {\hat{Θ}}_{i} = 2 π . \qquad ( 5 )$$

Various measurements have shown that even at constant speed of the magnetic object 102 in a lab environment, recorded time stamps have some noise parameters which arise because of clock jitter and vibrations coming from neighboring machine peripherals or speed regulators. This gives rise to a variable computed angle of each pole 104 for each revolution or rotation of the rotatable magnetic object 102. As will be described in more detail below, one technique to remove noise elements and to calculate the optimum pole angle or offset which may be provided is synchronous averaging. Another technique to compute the pole angle offset of pole angles is the use of a Kalman filter, which inherently removes noise by taking into account the variance of the recorded values. Both techniques will be described in more detail below.

a) With respect to synchronous averaging, ω₁, ω₂, . . . , ω_{M} will be assumed to be the angular speed calculated for M revolutions of the magnetic object 102 (and e.g. the tire 112). From this, the pole angles may be calculated by using the equation

$${ω}_{rev} = \frac{2 π}{{\sum }_{i = 1}^{N} {t}_{i}}$$

which can be written in matrix form as

$$\underline{Θ} = ( \begin{matrix}{Θ}_{11} & {Θ}_{12} & … & {Θ}_{1 M} \\ {Θ}_{21} & {Θ}_{22} & … & {Θ}_{2 M} \\ ⋮ & ⋮ & ⋱ & ⋮ \\ {Θ}_{N 1} & {Θ}_{N 2} & … & {Θ}_{NM}\end{matrix} ) , \qquad ( 6 )$$

where N is the number of poles and M is the total number of revolutions.

The average of each pole angle for a respective pole i 104 may be given by:

$${\hat{Θ}}_{i} == \frac{1}{M} {\sum }_{n = 1}^{M} {Θ}_{i , n} . \qquad ( 7 )$$

Various embodiments may find or determine the number of revolutions M, which shall be sufficient for the optimum angle calculation. For this reason, a recursive averaging algorithm may be used to compute successive approximations of the pole angles. After an arbitrary number m of revolutions, the value of the pole angle averaged over all the previous revolutions may have been determined.

This technique is superior to storing first N×M number of input samples and then averaging.

$${\hat{Θ}}_{i} = \frac{m - 1}{m} {\hat{Θ}}_{i}^{m - 1} + \frac{1}{m} {Θ}_{i}^{m} , \qquad ( 8 )$$

where \hat{Θ}ᵢ is the average value of the pole angle for pole i 104 after m revolutions of the magnetic object 102, e.g. the pole wheel 102 or the back-biased wheel 102. Θᵢ^{m} is the pole angle for pole i 104 calculated for the m^{th} revolution and \hat{Θ}ᵢ^{m-1} is the previous average for m−1 revolutions. To achieve more efficient averaging, an averaging of the angular speed may be provided over all the revolutions and then the pole angles may be computed and averaged. This may in various embodiments eliminate rapid changes in angular speed one step before the pole angle calculations and hence shall be more effective in calculating optimum pole angle.

$${\hat{ω}}_{i}^{m} = \frac{1}{m} {\sum }_{i = 1}^{m} {ω}_{i} , \qquad ( 9 )$$

wherein \hat{ω}ᵢ^{m} the speed average up to m revolutions, which may then be used to compute the pole angles for the m^{th} revolution. This may be used for the case when the angular speed is constant with small variations from revolution to revolution, for example. \hat{ω}ᵢ^{m} the same for all poles 104 for one particular revolution or rotation of the magnetic object 102.

b) With respect to Kalman filtering, it is to be noted that a Kalman filter may be provided to estimate the pole angle offset by utilizing the variance of the pole angle calculated from each revolution (in other words rotation) of the object 102. This variance may be assumed to be proportional to the variance of the generated (and usually recorded) time stamps for one particular magnetic pole 104. The following system may reflect one implementation of the Kalman filter neglecting some system dependent variable (but being of sufficient accuracy).

The following equations may be provided for the updating of the model:

$$\begin{matrix}{K}_{p} = {{σ}_{p}^{2} ( {σ}_{p}^{2} + {σ}_{m}^{2} )}^{- 1} , & ( 10 ) \\ {\hat{φ}}_{p}^{′} = {\hat{φ}}_{p} + {K}_{p} ( {δ}_{p} - {\hat{φ}}_{p} ) , & ( 11 ) \\ {\hat{σ}}_{p}^{2} = {σ}_{p}^{2} ( 1 - {K}_{p} ) . & ( 12 )\end{matrix}$$

wherein

Kₚ designates the Kalman filter gain;

σₘ² designates the measurement variance, which may be considered to be equal for all poles;

σₚ² designates the former variance of the pole angle offset;

\hat{σ}ₚ² designates the newly estimated variance of the pole p;

δₚ designates the calculated pole angle offset calculated from one revolution;

\hat{φ}ₚ′ designates the new estimate of the pole angle offset;

φₚ′ designates the old estimate of the pole angle offset.

Furthermore, the following equations are time update equations for the Kalman filter:

σₚ²=\hat{σ}+Qₚ, (13)

\hat{φ}=\hat{φ}ₚ′, (14)

wherein

Qₚ designates the noise factor.

σₚ² designates the former variance of the pole angle offset;

\hat{σ}ₚ² designates the newly estimated variance of the pole p;

\hat{φ}ₚ′ designates the new estimate of the pole angle offset;

φₚ′ designates the old estimate of the pole angle offset;

It should be noted that a Kalman filter can be tuned to achieve optimal results using filter parameters like noise factor etc. Furthermore, the convergence of pole angle offset may be faster with a Kalman filter as compared to synchronous averaging.

Referring back to FIG. 1, the magnetic object 102 may rotate for a first rotation. The first rotation may include a plurality of rotations in various embodiments. With the rotation of the magnetic object 102, also the one or more poles 104 will rotate. Thus, with the rotation of the one or more poles 104 over the magnetic sensor 106, the magnetic field provided by the magnetic object 102, e.g. by the one or more poles 104, and detected by the magnetic sensor 106 will change, dependent on the actual shape of the one or more poles 104.

The changes of the magnetic field over time may result in one or more magnetic field events, which may be detected by the magnetic sensor 106. Examples of a magnetic field may be, e.g.,
a magnetic field zero crossing;
a magnetic field extremum such as e.g. a magnetic field maximum or minimum;
an exceeding of a predefined threshold of the magnetic field;
a going below of a predefined threshold of the magnetic field;
a combination of the above; and the like.

For one or more of a respective one of the magnetic field events, the sensor or a processor (which may be provided in the sensor 106 or external from the sensor 106) may generate at least one time stamp based on the detection of the magnetic field event(s), e.g. representing the time instant(s) at which the magnetic field event(s) is or are detected.

Then, the sensor or processor may determine a model of the magnetic object using the at least one time stamp, wherein the model may include the determination of a (current revolution or current rotation) pole angle for a respective pole i 104, e.g. in accordance with

$${ω}_{rev} = \frac{2 π}{{\sum }_{i = 1}^{N} {t}_{i}}$$

and with equation (8) (and if desired with equation (4)) or using a Kalman filter (and if desired with equation (4)) as described above in real-time. Thus, the determined model illustratively describes a magnetic pattern caused by the respective revolution(s) or rotation(s) of the rotating object 102.

The revolution(s) or rotation(s) are continued and also the detection of the magnetic field event(s) is continued to thereby generate one or more further time stamps in the same way as described above. Furthermore, the model will be updated based on the one or more further time stamps, e.g. using the equations as described above.

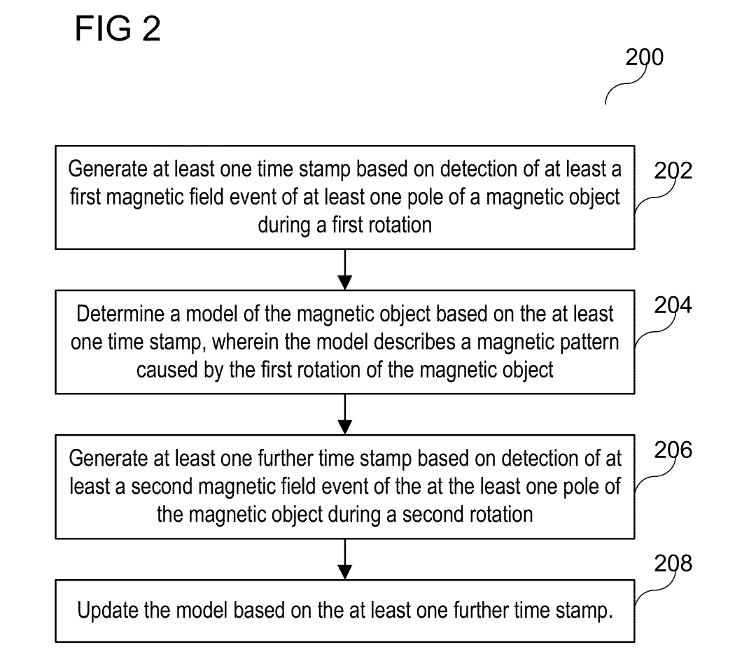

Thus, in summary, FIG. 2 shows a flow diagram 200 illustrating a method in accordance with various embodiments.

The method may include, in 202, generating at least one time stamp based on detection of at least a first magnetic field event of at least one pole of a magnetic object during a first rotation, and, in 204, determining a model of the magnetic object based on the at least one time stamp, wherein the model describes a magnetic pattern caused by the first rotation of the magnetic object. The method may further include, in 206, generating at least one further time stamp based on detection of at least a second magnetic field event of the at the least one pole of the magnetic object during a second rotation, and, in 208, updating the model based on the at least one further time stamp.

The magnetic object may include a magnetic pole wheel and/or a magnetic back-biased wheel. The first magnetic field event and the second magnetic field event may be of the same magnetic field event type, such as a magnetic field event as described above. By way of example, the at least one of the first magnetic field event and the second magnetic field event may include a magnetic field zero crossing of the detected magnetic field. The determining of the model may include determining a pole angle offset.

In various embodiments, the model may be updated by averaging a plurality of previously determined models. The averaging the plurality of previously determined models may be carried out using an Infinite Impulse Response filter, e.g. an Infinite Impulse Response filter for each of a plurality of magnetic poles of the magnetic object.

The method may further include determining a plurality magnetic pattern caused by the first rotation of the magnetic object that each indicate the length of the at least one pole of the magnetic pole wheel. wherein determining each of the plurality of magnetic patterns includes beginning the first rotation of the magnetic object at a different position of the magnetic object.

Although above mentioned techniques work well when the speed is constant but with an accelerating or decelerating pole wheel, the computed pole angle values start fluctuating as long the acceleration or deceleration continues and then they stabilize again once the speed is constant. In this case offset of each pole shall have an additional parameter of acceleration:

δₚ=εₚ′+pαₘ. (15)

wherein δₚ is the pole angle offset, p is the pole number (p=1, 2, . . . , N), δₚ′ is the pole offset when the speed is constant and αₘ is the acceleration factor for the m^{th} revolution or rotation. αₘ is considered to be constant for all poles 104 for one particular revolution or rotation. This assumption may be eliminated by a pole skipping technique, where one pole 104 or a plurality of poles 104 is skipped after each revolution or rotation to compensate for the speed change during one revolution or rotation. The final result may then be smoothed out by a running average of length N followed by an N×1 decimation filter, for example. In other words, determining at least one of the plurality of magnetic patterns may include beginning at a starting point that is determined based on at least one previous starting point of at least one first rotation by adding at least one of a predefined offset and a random offset to the previous starting point.

A respectively subsequent starting point may be determined based on the respectively previous starting point by adding a predefined offset. As an alternative, a respectively subsequent starting point may be determined based on the respectively previous starting point by adding a random offset.

As described above, the model may be updated in a recursive manner. By way of example, the recursively updating the model may include determining an average pole angle \hat{Θ}ᵢ for the pole i after a number of m rotations of the object based on the expression (8) as described above. As an alternative, the recursively updating the model may include determining an average pole angle \hat{Θ}ᵢ for the pole i after a number of m rotations of the object using a Kalman filter.

The method may further include adjusting a time stamp sequence which in turn may include at least some of the time stamps and/or at least some of the further time stamps to compensate the influence of a length of at least one half period of a magnetic field caused by a pole (e.g. 104) of the magnetic object (e.g. 102) based on the updated model. The time stamps may be adjusted by adding a variable delay to thereby adjust the influence of the model on the length of at least one half period of a magnetic field caused by a pole (e.g. 104) of the magnetic object (e.g. 102). As an alternative, the time stamps may be adjusted by predicting a subsequent predefined magnetic field event caused by the magnetic object (e.g. 102) based on the model and at least two previous predefined magnetic field event caused by magnetic object (e.g. 102).

The method may further include determining a total number of poles of the object based on the generated time stamps.

Illustratively, various embodiments may extract regularities in the pattern of the timestamps generated by ABS wheel speed sensors, which are caused by non-ideal length of the poles (e.g. 104) of a magnetic object (e.g. 102, e.g. of a pole wheel or a back-biased wheel).

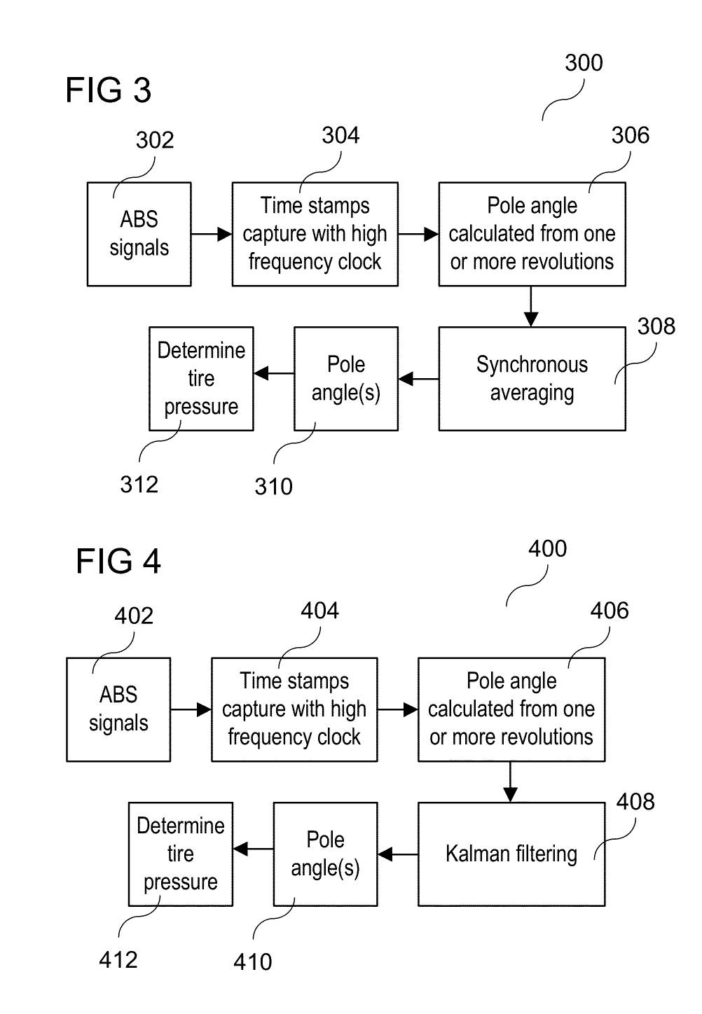

FIG. 3 shows a block diagram 300 illustrating various processes in accordance with various embodiments. When the magnetic object's (e.g. pole wheel(s)') angular speed is constant, synchronous averaging may be provided to extract optimum pole angle(s) or pole angle offset(s). No prior knowledge of system noise parameters is needed in this case.

As shown in FIG. 3 and as has already been described above, the magnetic sensor 106 may provide sensor signals 302 (e.g. ABS sensor signals 302). Then, time stamps may be generated (in other words captured), which e.g. describe the time instants at which a predefined magnetic field event (such as described above) occur (block 304), e.g. using a high frequency clock. Then, as symbolized in block 306, the pole angle(s) of one or more poles 104 may be calculated as outlined above from one or more revolution(s) or rotation(s), respectively. The pole angle(s) and/or the pole angle offset(s) may be determined from one or more revolution(s) or rotation(s) using e.g. synchronous averaging as described above (block 308). The result of this processing stage is thus one or a plurality of pole angle(s) and/or the pole angle offset(s) (block 310), which may be provided for further processing, e.g. for the estimation of a tire pressure in block 312.

FIG. 4 shows a block diagram 400 illustrating various processes in accordance with various embodiments. When the magnetic object's (e.g. pole wheel(s)') angular speed is constant, Kalman filtering may be provided to extract optimum pole angle(s) or pole angle offset(s). This method may be particularly accurate if prior knowledge/estimate of system noise parameters is available.

As shown in FIG. 4 and as has already been described above, the magnetic sensor 106 may provide sensor signals 402 (e.g. ABS sensor signals 402). Then, time stamps may be generated (in other words captured), which e.g. describe the time instants at which a predefined magnetic field event (such as described above) occur (block 404), e.g. using a high frequency clock. Then, as symbolized in block 406, the pole angle(s) of one or more poles 104 may be calculated as outlined above from one or more revolution(s) or rotation(s), respectively. The pole angle(s) and/or the pole angle offset(s) may be determined from one or more revolution(s) or rotation(s) using e.g. Kalman filtering as described above (block 408). The result of this processing stage is thus one or a plurality of pole angle(s) and/or the pole angle offset(s) (block 410), which may be provided for further processing, e.g. for the estimation of a tire pressure in block 412.

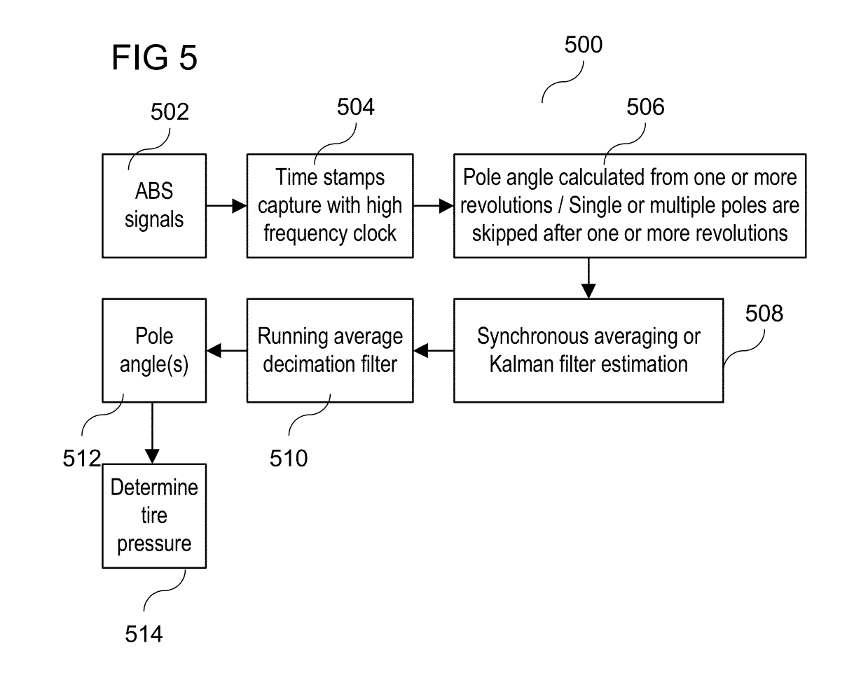

FIG. 5 shows a block diagram 500 illustrating various processes in accordance with various embodiments. When the magnetic object's (e.g. pole wheel(s)') angular speed is not constant, the pole angle(s) or pole angle offset(s) may be calculated from each revolution or rotation, for example, but skipping one/multiple poles after each revolution or rotation may be provided. This may compensate for the variation in speed. This in result may require a running averaging filter at the output of synchronous averaging or Kalman filtering to remove ripples in the pole angle/pole angle offset calculations.

As shown in FIG. 5 and as has already been described above, the magnetic sensor 106 may provide sensor signals 502 (e.g. ABS sensor signals 502). Then, time stamps may be generated (in other words captured), which e.g. describe the time instants at which a predefined magnetic field event (such as described above) occur (block 504), e.g. using a high frequency clock. Then, as symbolized in block 506, the pole angle(s) of one or more poles 104 may be calculated as outlined above from one or more revolution(s) or rotation(s), respectively. In this process, one or more poles may be skipped after each revolution or rotation. The pole angle(s) and/or the pole angle offset(s) may be determined from one or more revolution(s) or rotation(s) using e.g. synchronous averaging or Kalman filter estimation as described above (block 508). Furthermore, as shown in block 510, a running average may be provided, e.g. using a decimation filter. The result of this processing stage is thus one or a plurality of pole angle(s) and/or the pole angle offset(s) (block 512), which may be provided for further processing, e.g. for the estimation of a tire pressure in block 514.

The above described processes may be implemented in various arrangements, some of which will be described in more detail below.

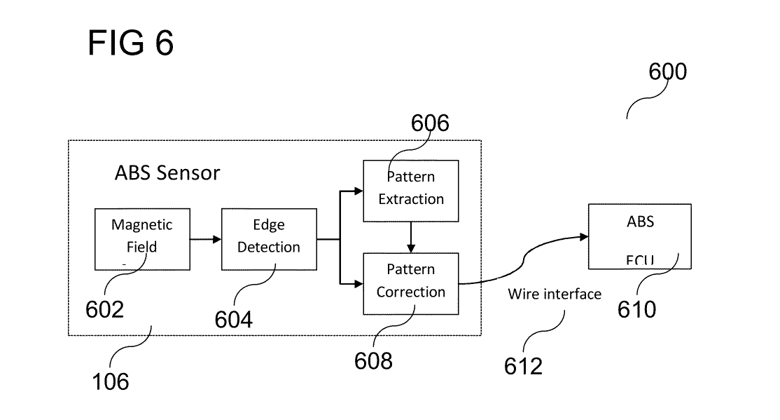

FIG. 6 shows a block diagram illustrating an arrangement 600 in accordance with various embodiments. The above described pattern extraction algorithm may be implemented inside the sensor 106 (e.g. inside the ABS sensor) provided e.g. that it has an integrated digital signal processor (DSP) to perform necessary calculation overhead.

The arrangement 600 may include a sensor 106, e.g. an ABS sensor 106. The sensor may be configured to detect a magnetic field 602. The sensor 106 may include an edge detection unit 604 which may be configured to detect e.g. the above-described zero-crossing of the detected (varying) magnetic field 602. The sensor 106 may further include a pattern extraction unit (which may also be referred to as model extraction unit) 606. The pattern extraction unit 606 may be configured to determine the pole angle(s) of the one or more poles 104, as described above. Furthermore, a pattern correction unit (which may also be referred to as model correction unit) 608 may be provided which may be configured to determine the updated model (e.g. the updated pole angle(s) of the one or more poles 104). The determined respectively updated pole angle(s) of the one or more poles 104 may be transmitted to a sensor external ECU (engine control unit) 610, e.g. via a wire interface 612 or a wireless interface. The ECU 610 may be configured to determine the tire pressure, e.g. of the tire 110, using the determined updated polar angle(s) and/or updated polar angle offset(s).

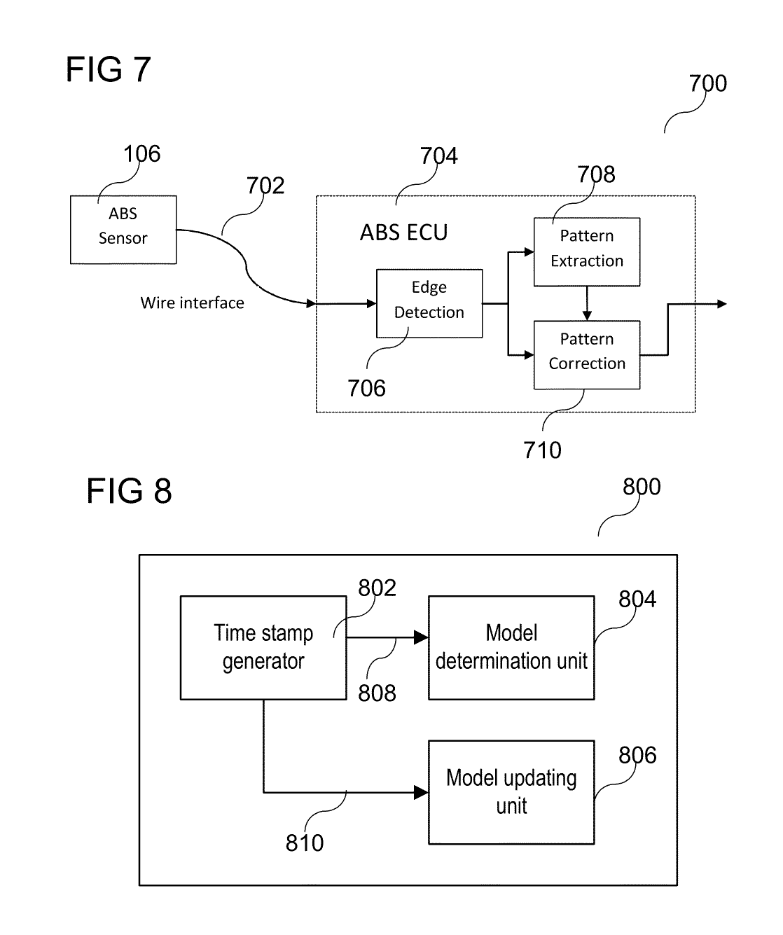

FIG. 7 shows a block diagram illustrating an arrangement 700 in accordance with various embodiments. The above described pattern extraction algorithm may be implemented inside the ECU 704 in case that the sensor 106 cannot perform necessary calculation overhead.

The arrangement 700 may include a sensor 106, e.g. an ABS sensor 106. The sensor 106 may be configured to detect a magnetic field and may transmit the detected magnetic field values to the sensor external ECU (engine control unit) 704, e.g. via a wire interface 702 or a wireless interface. The ECU 704 may include an edge detection unit 706 which may be configured to detect e.g. the above-described zero-crossing of the received detected (varying) magnetic field values. The ECU 704 may further include a pattern extraction unit (which may also be referred to as model extraction unit) 708. The pattern extraction unit 708 may be configured to determine the pole angle(s) of the one or more poles 104, as described above. Furthermore, a pattern correction unit (which may also be referred to as model correction unit) 710 may be provided which may be configured to determine the updated model (e.g. the updated pole angle(s) of the one or more poles 104). The ECU 704 (or a further processor not shown in the figure) may be configured to determine the tire pressure, e.g. of the tire 110, using the determined updated polar angle(s) and/or updated polar angle offset(s).

In various embodiments, an arrangement 800 may be provided as shown in FIG. 8. The arrangement 800 may include a time stamp generator 802 configured to generate at least one time stamp 808 based on detection of a first magnetic field event of at least one pole of a magnetic object during a first rotation; a model determination unit 804 configured to determine a model of the magnetic object based on the one or more time stamps 808, wherein the model describes a magnetic pattern caused by the first rotation of the magnetic object. The time stamp generator 802 may further be configured to generate at least one further time stamp 810 based on detection of a second magnetic field event of the at the least one pole of the magnetic object during a second rotation; and a model updating unit 806 configured to update the model based on the at least one further time stamp 810.

The magnetic object may include or be a magnetic pole wheel and/or a magnetic back-biased wheel.

The arrangement may further include at least one sensor configured to detect at least one of the first magnetic field event of at least one pole and the second magnetic field event of at least one pole. The first magnetic field event and the second magnetic field event may be of the same magnetic field event type. Furthermore, the model updating unit may be configured to update the model based on averaging a plurality of previously determined models. The model updating unit may include an Infinite Impulse Response filter configured to average the plurality of previously determined models. Furthermore, the model updating unit may be configured to recursively update the model. The model updating unit may configured to determine an average pole angle \hat{Θ}ᵢ for the pole i after m rotations of the object based on the expression (8) as described above. As an alternative, the model updating circuit may be configured to update the model based on a Kalman filter. The parameters of the Kalman filter may be updated using the expressions as described above.

The arrangement may further include at least one sensor configured to detect at least one of the first magnetic field event of at least one pole and the second magnetic field event of at least one pole. The at least one sensor is configured to detect a magnetic field zero crossing as at least one of the first magnetic field event and the second magnetic field event. Furthermore, the model determination circuit is configured to determine a pole angle offset. The model updating circuit may be configured to update the model by averaging a plurality of previously determined models. The model updating circuit may include an Infinite Impulse Response filter structure to average the plurality of previously determined models. The model updating circuit may include an Infinite Impulse Response filter for each magnetic pole to average the plurality of previously determined models.

The arrangement may further include a circuit configured to adjust a time stamp sequence comprising at least one of at least some of the time stamps and some of the further time stamps to compensate the influence of a length of at least one half period of a magnetic field caused by a pole of the magnetic object based on the updated model. The circuit may be configured to adjust the time stamps by adding a variable delay to thereby adjust the influence of the model on the length of at least one half period of a magnetic field caused by a pole of the object. Furthermore, the circuit may be configured to adjust the time stamps by predicting a subsequent predefined magnetic field event caused by the object based on the model and at least two previous predefined magnetic field event caused by object.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A method, comprising:
generating at least one time stamp based on detection of at least a first magnetic field event of at least one pole of a magnetic object during a first rotation;
determining a model of the magnetic object based on the at least one time stamp, wherein the model describes a magnetic pattern caused by the first rotation of the magnetic object;
generating at least one further time stamp based on detection of at least a second magnetic field event of the at the least one pole of the magnetic object during a second rotation; and
updating the model based on the at least one further time stamp.

2. The method of claim 1,
wherein the magnetic object comprises at least one of a magnetic pole wheel and a magnetic back-biased wheel.

3. The method of claim 1,
wherein the first magnetic field event and the second magnetic field event are of the same magnetic field event type.

4. The method of claim 1,
wherein at least one of the first magnetic field event and the second magnetic field event comprise a magnetic field zero crossing.

5. The method of claim 1,
wherein the determining the model comprises determining a pole angle offset.

6. The method of claim 1,
wherein the updating the model comprises averaging a plurality of previously determined models.

7. The method of claim 6,
wherein the averaging the plurality of previously determined models comprises using an Infinite Impulse Response filter.

8. The method of claim 7,
wherein the averaging the plurality of previously determined models comprises using an Infinite Impulse Response filter for each of a plurality of magnetic poles of the magnetic object.

9. The method of claim 1, further comprising:
determining a plurality magnetic pattern caused by the first rotation of the magnetic object that each indicate the length of the at least one pole of the magnetic pole wheel; and
wherein determining each of the plurality of magnetic patterns comprises beginning the first rotation of the magnetic object at a different position of the magnetic object.

10. The method of claim 9,
wherein determining at least one of the plurality of magnetic patterns comprises beginning at a starting point that is determined based on at least one previous starting point of at least one first rotation by adding at least one of a predefined offset and a random offset to the previous starting point.

11. The method of claim 1, further comprising:
recursively updating the model.

12. The method of claim 11,
wherein recursively updating the model comprises determining an average pole angle \hat{Θ}ᵢ for the pole i after a number of m rotations of the object based on the expression:
$${\hat{Θ}}_{i} = \frac{m - 1}{m} {\hat{Θ}}_{i}^{m - 1} + \frac{1}{m} {Θ}_{i}^{m} ,$$
wherein Θᵢ^{m} is a pole angle for a pole i calculated for an m^{th} rotation of the magnetic object and wherein \hat{Θ}ᵢ^{m-1} is a previous average pole angle for the pole after m−1 rotations of the object.

13. The method of claim 1,
wherein updating the model comprises using a Kalman filter.

14. The method of claim 13,
wherein updating the model using the Kalman filter comprises applying the following expression to determine parameters of the Kalman filter:
Kₚ=σₚ²(σₚ²+σₘ²)⁻¹,
\hat{φ}ₚ′=\hat{φ}ₚ+Kₚ(δₚ−\hat{φ}ₚ),
\hat{σ}ₚ²=σₚ²(1−Kₚ),
wherein
Kₚ designates the Kalman filter gain;
σₘ² designates the measurement variance, which may be considered to be equal for all poles;
σₚ² designates the former variance of the pole angle offset;
\hat{σ}ₚ² designates the newly estimated variance of the pole p;
δₚ designates the calculated pole angle offset calculated from one revolution;
\hat{φ}ₚ′ designates the new estimate of the pole angle offset.
φₚ′ designates the old estimate of the pole angle offset.

15. The method of claim 14,
wherein updating the model using the Kalman filter comprises applying the following expression to update the parameters of the Kalman filter:
σₚ²=\hat{σ}ₚ²+Qₚ,
\hat{φ}=\hat{φ}ₚ′,
wherein
Qₚ designates the noise factor;
σₚ² designates the former variance of the pole angle offset;
\hat{σ}ₚ² designates the newly estimated variance of the pole p;
\hat{φ}ₚ′ designates the new estimate of the pole angle offset;
φₚ′ designates the old estimate of the pole angle offset.

16. An arrangement, comprising:
a time stamp generator configured to generate at least one time stamp based on detection of a first magnetic field event of at least one pole of a magnetic object during a first rotation;
a model determination unit configured to determine a model of the magnetic object based on the time stamps, wherein the model describes a magnetic pattern caused by the first rotation of the magnetic object;
wherein the time stamp generator is further configured to generate at least one further time stamp based on detection of a second magnetic field event of the at the least one pole of the magnetic object during a second rotation; and
a model updating unit configured to update the model based on the at least one further time stamp.

17. The arrangement of claim 16,
wherein the magnetic object comprises one of a magnetic pole wheel and a magnetic back-biased wheel.

18. The arrangement of claim 16, further comprising:
at least one sensor configured to detect at least one of the first magnetic field event of at least one pole and the second magnetic field event of at least one pole.

19. The arrangement of claim 18,
wherein the first magnetic field event and the second magnetic field event are of the same magnetic field event type.

20. The arrangement of claim 16,
wherein the model updating unit is configured to update the model based on averaging a plurality of previously determined models.

21. The arrangement of claim 20,
wherein the model updating unit comprises an Infinite Impulse Response filter configured to average the plurality of previously determined models.

22. The arrangement of claim 16,
wherein the model updating unit is configured to recursively update the model.

23. The arrangement of claim 22,
wherein the model updating unit is configured to determine an average pole angle \hat{Θ}ᵢ for the pole i after m rotations of the object based on the expression:
$${\hat{Θ}}_{i} = \frac{m - 1}{m} {\hat{Θ}}_{i}^{m - 1} + \frac{1}{m} {Θ}_{i}^{m} ,$$
wherein \hat{Θ}ᵢ^{m} is the pole angle for the pole i calculated for the m^{th} rotation of the object and wherein \hat{Θ}ᵢ^{m-1} is the previous average pole angle for the pole i after m−1 rotations of the object.

24. The arrangement of claim 16,
wherein the model updating circuit is configured to update the model based on a Kalman filter.

25. The arrangement of claim 24,
wherein the parameters of the Kalman filter are determined as follows:
Kₚ=σₚ²(σₚ²+ρₘ²)⁻¹,
\hat{φ}ₚ′=\hat{φ}ₚ+Kₚ(δₚ−\hat{φ}ₚ),
\hat{σ}ₚ²=σₚ²(1−Kₚ),
wherein
Kₚ designates the Kalman filter gain;
σₘ² designates the measurement variance, which may be considered to be equal for all poles;
σₚ² designates the former variance of the pole angle offset;
\hat{σ}ₚ² designates the newly estimated variance of the pole p;
δₚ designates the calculated pole angle offset calculated from one revolution;
\hat{φ}ₚ′ designates the new estimate of the pole angle offset.
φₚ′ designates the old estimate of the pole angle offset.

26. The arrangement of claim 25,
wherein the parameters of the Kalman filter are updated in accordance with:
σₚ²=\hat{σ}ₚ²+Qₚ,
\hat{φ}=\hat{φ}ₚ′,
wherein
Qₚ designates the noise factor;
σₚ² designates the former variance of the pole angle offset;
\hat{σ}ₚ² designates the newly estimated variance of the pole p;
\hat{φ}ₚ′ designates the new estimate of the pole angle offset;
φₚ′ designates the old estimate of the pole angle offset.
